(19) United States
(12) Patent Application Publication
(10) Pub. No.: US 2016/0063623 A1
(43) Pub. Date: Mar. 3, 2016

(54) Methods and Apparatus for Determining and Displaying the Constituent Components of a Trading Strategy

(71) Applicant: TRADING TECHNOLOGIES INTERNATIONAL INC., CHICAGO, IL (US)

(72) Inventors: Patrick Joseph Rooney, St. Charles, IL (US); William Tigard Baker, Hoffman Estates, IL (US); Thomas Jeffrey Weiss, Skokie, IL (US)

(21) Appl. No.: 14/476,714

(22) Filed: Sep. 3, 2014

(51) Int. Cl. G06Q 40/04

(52) U.S. Cl. CPC G06Q 40/04

(57) ABSTRACT

Certain embodiments provide a method for defining, via a trading interface implemented by a trading device, a trading strategy including a first contract associated with a first tradeable object and a second contract associated with a second tradeable object. The example method also includes receiving, by the trading device, market data provided by the electronic exchange, the market update includes price and quantity information related to the first and second tradeable objects. The example method also includes determining, by the trading device, that at least one of a first price and a first quantity associated with the first contract is implied based on at least one of a second price and a second quantity associated with the second contract. The example method also includes receiving, via the trading interface implemented by the trading device, a selection input corresponding to the trading strategy listed in the trading interface, and displaying, via the trading interface implemented by the trading device, a strategy indicator arranged to identify the trading strategy in the trading interface, wherein the strategy indicator is generated in response to the received selection input; and displaying, via the trading interface implemented by the trading device, an implied indicator arranged to identify the first contract and configured to reflect a link between at least the first contract and the selected trading strategy.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Trading applications create interactive trading interfaces for traders to participate in at least one market. The trading interfaces enable traders to monitor the market information for the electronic exchange (e.g., monitor positions, obtain market quotes, etc.) and submit trade orders to the electronic exchange. To assist traders in getting the best prices for their trade orders, it is necessary for the trader to be presented with as much information as available regarding the portions of the trade orders.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 illustrates a block diagram of an example constituent components handling module in communication with the computing device of FIG. 3.

FIG. 6 illustrates an example graphical user interface generated by the example constituent components handling module of FIG. 5.

FIGS. 7-9 illustrate block diagrams representative of example trading interfaces in which certain embodiments may be deployed.

FIG. 10 illustrates a flow diagram of an example method to determine and display the constituent components of a trading strategy.

FIG. 11 illustrates a flow diagram of an example method to update indicators associated with the components in a trading strategy.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This patent relates generally to electronic trading and, more particularly, to methods and apparatus for determining and displaying the constituent components of a trading strategy.

In general, a market participant desires to be able to react more quickly than other market participants. For example, a market participant (or trader or other user) generally desires to be “first-to-market” (e.g., to have trade orders entered prior to other market participants entering the same or similar orders). It is therefore desirable to improve the way market data is displayed to the market participant and to allow the market participant to make fast and accurate order entry. A speed advantage may give a market participant a competitive advantage.

Trading applications allow market participants to initiate trade actions via a trading device. In some examples, a trading application user interface may present (e.g., display) market data or other information via a trading window(s) or trading screen(s). For example, a trading window may be a portion of the user interface and display market updates, charts, positions, news, analysis, etc. A market grid is an example of a trading window that facilitates monitoring and selecting contract information for trading. For example, the market grid may include a user-selectable list of contracts subscribed to by the market participant. Selecting one of the contracts may give you the market information for that contract (e.g., bid/ask price, bid/ask quantities, etc.). The price of the contract is referred to herein as the “direct price” (e.g., the price of an explicit order).

In some examples, the market grid may include trading strategies such as spreads. As described in detail below, a trading strategy defines a relationship between two or more tradeable objects (e.g., instruments, options, future contracts, etc.) to be traded at the same time. Each transaction or trade of a tradeable object included in the trading strategy may be referred to as, for example, a leg of a spread. In certain embodiments, trading systems may define the legs of the spread and then calculate a spread price by adding and/or subtracting the price of each defined leg.

Example methods and apparatus disclosed herein display one or more trading strategies in a market grid for selection by a market participant to trade. When the market participant (e.g., a user and/or a trading application) selects a trading strategy, examples disclosed herein associate the selected trading strategy with an indicator such as text, icons, colors, lines and/or other graphical representations. For example, an indicator may be represented as highlighting which is displayed as an overlay on a row associated with the selected trading strategy.

In some examples, when a trading strategy is selected, parameters associated with the selected trading strategy may be updated on the market grid and/or another portion of the trading window. Examples disclosed herein calculate the price of the trading strategy when selected. If the price of the selected trading strategy is based on implied prices, examples disclosed herein (1) identify the one or more implied components (e.g., contracts) relied upon (e.g., used) to calculate the trading strategy price and (2) update the market grid to include the implied contracts (also referred to as implied orders). Unlike direct prices which reflect the price of an explicit order, implied prices are derived from direct prices. For example, an implied price may be a synthetically generated tradeable price from orders in outright contracts (e.g., direct orders) and spreads. In some examples, an implied contract may not be included in the market grid when the trading strategy was selected, but the implied contract is added to the market grid when the market grid is updated. Just as it is useful for a market participant to know (e.g., see) every direct order that is in a particular market when trading in that market, it is also useful to know every order that has been implied into the trading strategy. For example, orders in outright markets (e.g., legs of a spread) may imply orders into a spread market and cause an effect on another trading strategy monitored by the market participant. An implied order includes implied prices and/or quantities that are derived from direct orders and/or other implied markets in a combination of outright markets and trading strategies.

In some examples, it may be useful to identify the relationship between the selected trading strategy and the relied upon components (e.g., related contracts). Examples disclosed herein display an indicator associated with the related contracts. To illustrate the relationship between a selected trading strategy and the relied upon components, the selected trading strategy is associated with a first indicator (e.g., a selected strategy indicator) and the relied upon components are associated with a second indicator (e.g., an implied component indicator). For example, the settings for the highlighting overlay may be modified and/or adjusted to differentiate the selected trading strategy and the relied upon components. In the illustrated example, the first indicator is a highlighting displayed as an overlay having a transparency parameter of 50%, and the implied contract indicator is a highlighting displayed as an overlay having a transparency parameter of 70%, where a larger transparency parameter is associated with less opacity (e.g., the transparency parameter of 70% appears nested (e.g., inclusive) with respect to the transparency parameter of 50%) (e.g., 0% transparency appears as if no indicator is associated with the relied upon components). In this manner, the inter-related nature of the trading strategies and the contracts listed in the market grid may be quickly discerned by the market participant.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

While some examples described herein may refer to functions performed by one or more given actors such as “users,” “market participants” and/or other entities, it should be understood that this is for purposes of explanation only. The claims should not be interpreted to require action by any such example actor unless explicitly required by the language of the claims themselves.

### I. Brief Description of Certain Embodiments

Certain embodiments provide a method for defining, via a trading interface implemented by a trading device, a trading strategy including a first contract associated with a first tradeable object and a second contract associated with a second tradeable object. The example method also includes receiving, by the trading device, market data provided by the electronic exchange, the market update includes price and quantity information related to the first and second tradeable objects. The example method also includes determining, by the trading device, that at least one of a first price and a first quantity associated with the first contract is implied based on at least one of a second price and a second quantity associated with the second contract. The example method also includes receiving, via the trading interface implemented by the trading device, a selection input corresponding to the trading strategy listed in the trading interface, and displaying, via the trading interface implemented by the trading device, a strategy indicator arranged to identify the trading strategy in the trading interface, wherein the strategy indicator is generated in response to the received selection input; and displaying, via the trading interface implemented by the trading device, an implied indicator arranged to identify the first contract and configured to reflect a link between at least the first contract and the selected trading strategy.

Certain embodiments provide a tangible computer readable storage medium comprising instructions that, when executed, cause a trading device to at least receive a definition of a trading strategy including a first contract associated with a first tradeable object and a second contract associated with a second tradeable object, and receive market data provided by the electronic exchange, the market update includes price and quantity information related to the first and second tradeable objects. The example instructions to cause the trading device to determine that at least one of a first price and a first quantity associated with the first contract is implied based on at least one of a second price and a second quantity associated with the second contract. The example instructions to also to cause the trading device to receive a selection input corresponding to the trading strategy listed in the trading interface, display a strategy indicator arranged to identify the trading strategy in the trading interface, wherein the strategy indicator is generated in response to the received selection input, and display an implied indicator arranged to identify the first contract and configured to reflect a link between at least the first contract and the selected trading strategy.

Certain embodiments provide a method including facilitating definition of a trading strategy having a first leg associated with a first tradeable object and a second leg associated with a second tradeable object, the first tradeable object and the second tradeable object listed on an electronic exchange, and displaying the defined trading strategy in a trading interface. The example method also includes calculating a price associated with the defined trading strategy, the price based on an implied contract associated with the first leg. The example method also includes generating an indicator associating the implied contract to the defined trading strategy, and displaying the indicator via the trading interface.

### II. Example Electronic Trading System

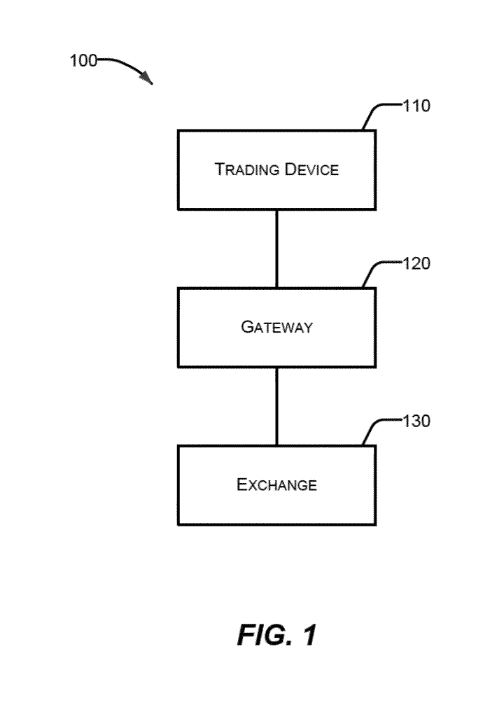

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

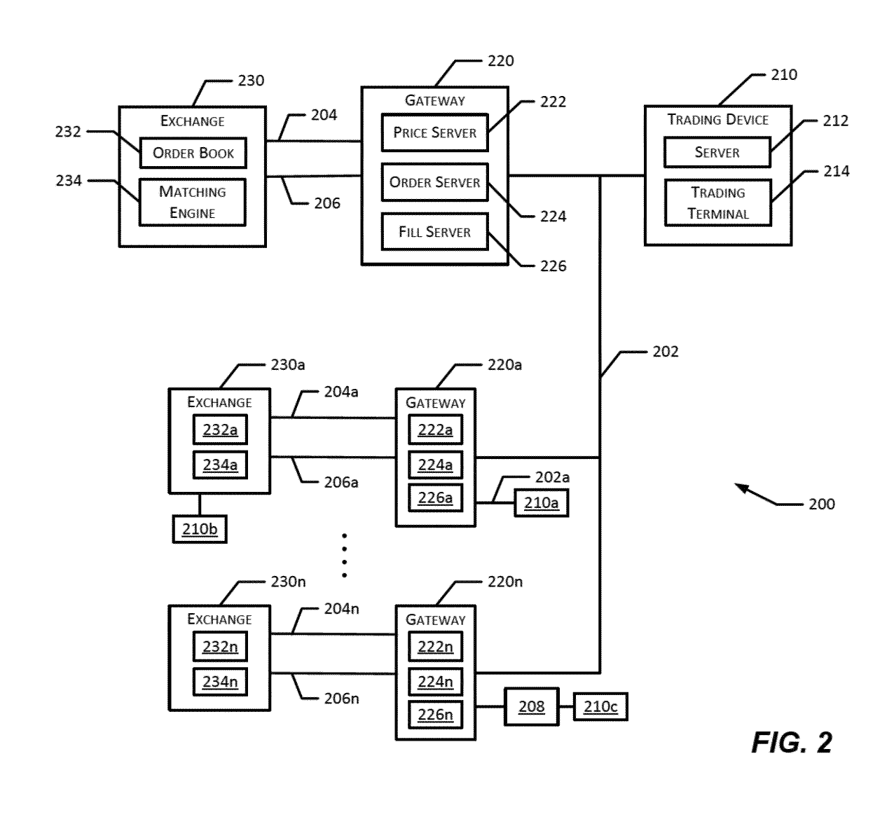

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

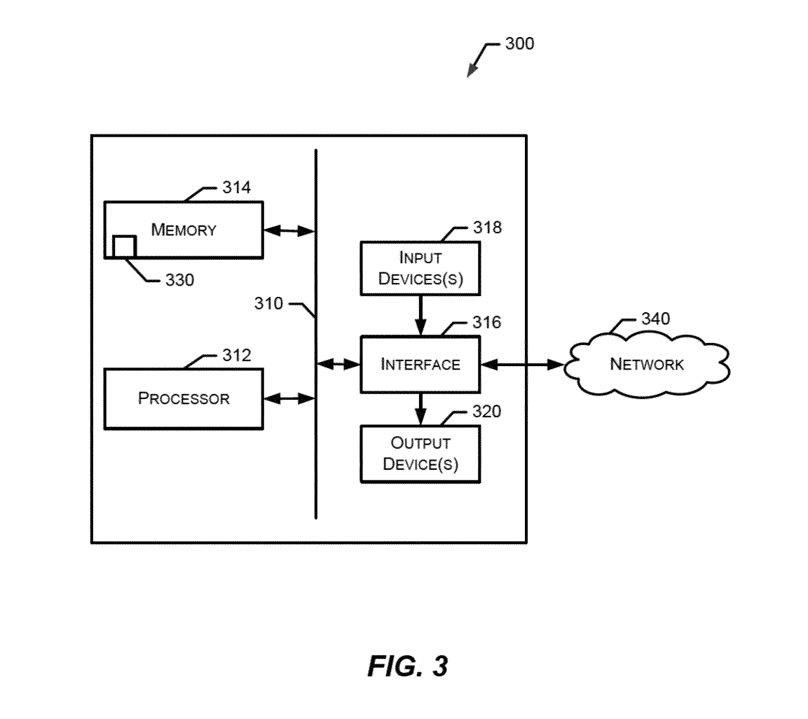

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

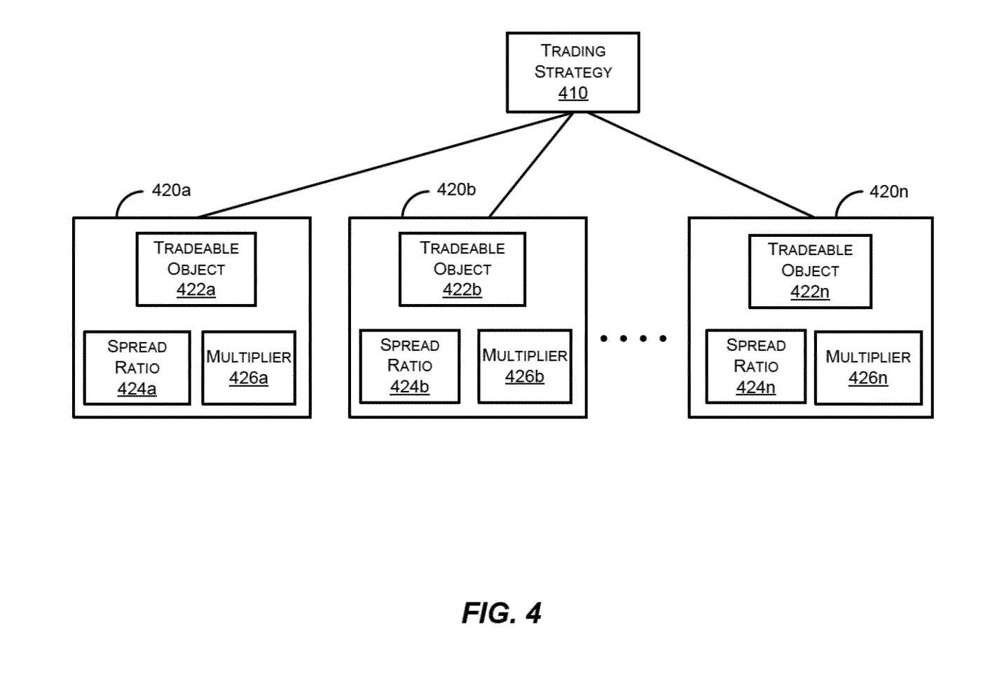

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Example Constituent Component Handling Module, Systems and Methods

Example systems and methods to determine and display constituent components of a trading strategy are disclosed and described herein. Using a trading interface, when a trading strategy is selected, the trading strategy is highlighted on the trading interface. In addition, the components (e.g., legs) of the selected trading strategy are also displayed on the trading interface.

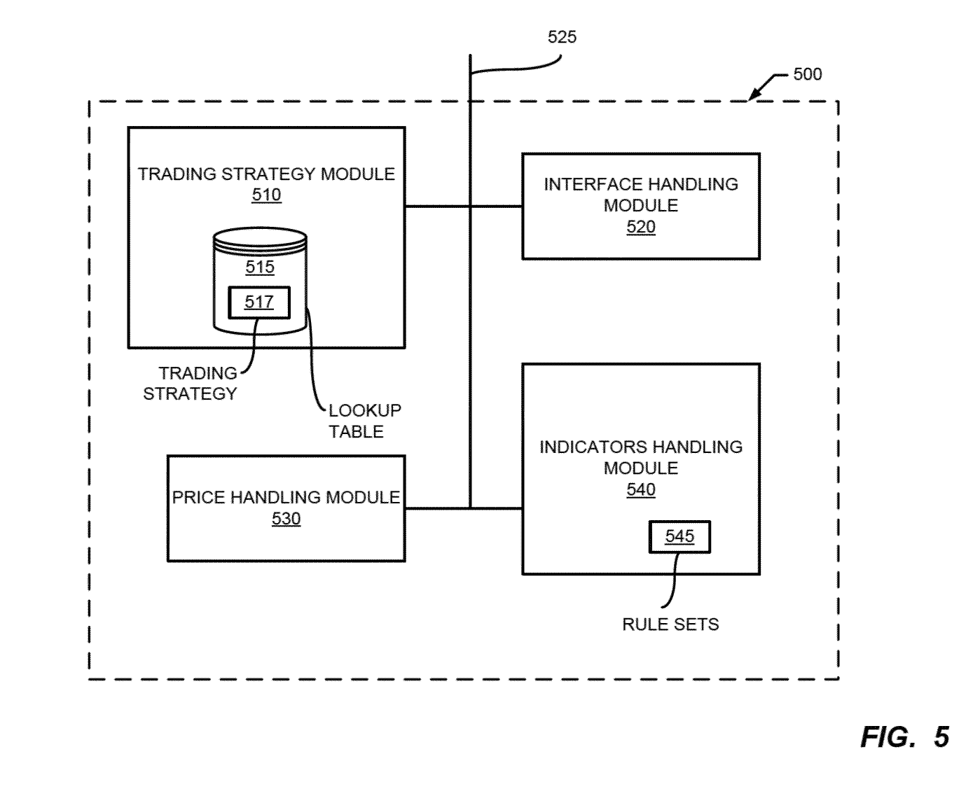

In certain examples, the computing device 300 includes a constituent components handling module 500 to identify and display constituent components of a trading strategy. FIG. 5 illustrates a block diagram of an example constituent components handling module 500. The constituent components handling module 500 operates in connection with the processor 312, the memory 314, the interface 316, the input device(s) 318 and/or output device(s) 320 of the example FIG. 3. The constituent components handling module 500 is able to communicate with and/or control the computing device 300 via the processor 312, the input device(s) 318 and/or the output device(s) 320. The constituent components handling module 500 leverages these communications to interact with and control the operation of the trading application 330. Additionally, the constituent components handling module 500 is able to utilize the memory 314 of the computing device 300. In some examples, the constituent components handling module 500 operates as a subsidiary module of the trading application 330. In other examples, the constituent components handling module 500 operates as a discrete device in the computing device 300.

In the illustrated example of FIG. 5, the constituent components handling module 500 includes an example trading strategy module 510, an example interface handling module 520, an example price handling module 530 and an example indicators handling module 540. The example constituent components handling module 500 includes the trading strategy module 510 to define one or more trading strategies and to store the defined trading strategies for subsequent processing (e.g., executing a trade using one or more of the defined trading strategies). The example interface handling module 520 displays and facilitates manipulating a trading interface including a market grid. The example constituent components handling module 500 includes the price handling module 530 to calculate the price of the selected ones of the trading strategies. The example indicators handling module 540 manages the display of the constituent components of the selected ones of the trading strategies. Additionally, the components of the constituent components handling module 500 are in communication with one another as well as with the computing device 300 of FIG. 3 via an example communication bus 525.

The example trading strategy module 510 operates in conjunction with a trading application such as the example trading application 330 of FIG. 3. In the illustrated example, the trading strategy module 510 facilitates defining a trading strategy (e.g., a spread) used to calculate a strategy price. For example, the trading strategy module 510 may receive one or more parameters (e.g., a multiplier, a spread ratio, etc.) associated with defining a component (e.g., a leg) of the trading strategy. In some examples, the trading strategy module 510 facilitates defining (e.g., describing) a relationship between the components of the trading strategy. For example, the product of two components may be used to calculate a strategy price. In some examples, the relationship between the legs may include addition, subtraction, multiplication, division and/or any other mathematical operation relating the components to a strategy price. In the illustrated example, the trading strategy module 510 stores defined trading strategies in an example data structure such as a database or lookup table 515. For example, the trading strategy module 510 may store an example trading strategy 517 as it is defined by a market participant in the lookup table 515 for future retrieval.

In some examples, one or more of the components of the trading strategy 517 may include implied orders. For example, a trade order in an outright (e.g., direct) market may imply orders into a spread market. An implied order includes implied prices and/or quantities that are derived from direct orders in a combination of outright markets and trading strategies. For example, a market participant may define a trading strategy (e.g., “Spread AB”) to include buying one unit of a first tradeable object in a first outright market (e.g., “Leg A”) and selling one unit of a second tradeable object in a second outright market (e.g., “Leg B”). In some such examples, the first and second tradeable objects can imply orders into a spread market (e.g., the “Spread AB”).

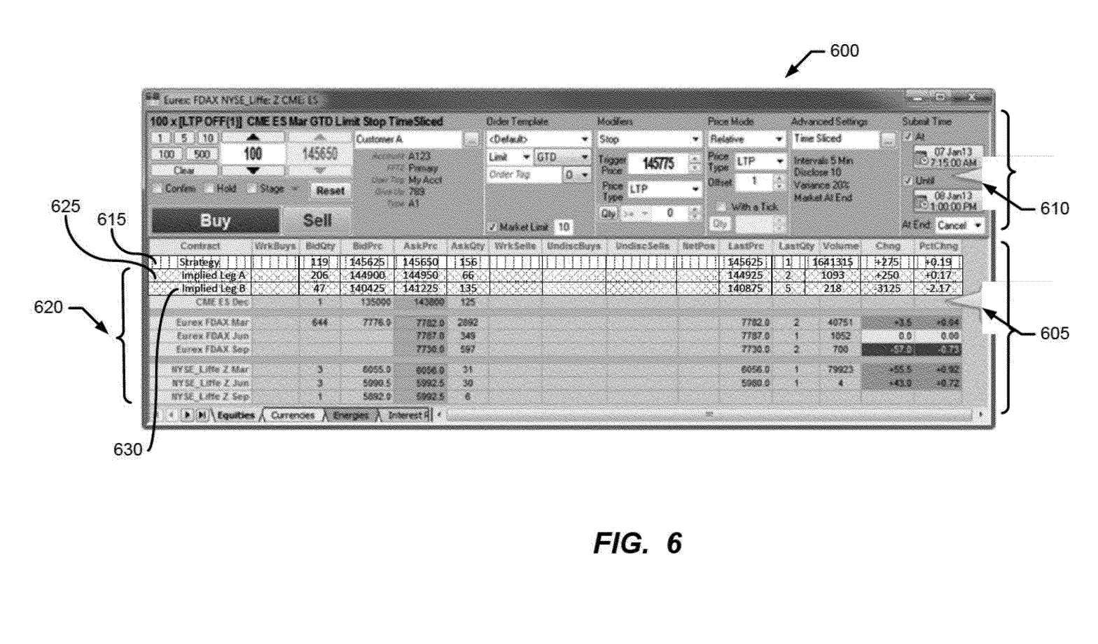

In the illustrated example of FIG. 5, the constituent components handling module 500 includes the example interface handling module 520 to display and/or generate a trading interface for presentation to a market participant. For example, the interface handling module 520 may present a graphical user interface such as an example trading interface 600, described in greater detail in connection with FIG. 6. In the illustrated example, the interface handling module 520 generates a market grid to display trading strategies. For example, the interface handling module 520 may retrieve one or more trading strategies 517 from the example data structure 515 and present the retrieved trading strategies 517 in the market grid. In some examples, the interface handling module 520 displays the trading strategies 517 in a user-selectable list. In some such examples, a market participant may select one or more of the trading strategies 517 to obtain additional information about the selected ones of the trading strategies 517.

FIG. 6 depicts an example constituent components graphical user interface (GUI) 600 (referred to hereinafter as the “constituent component interface”) of the example constituent components handling module 500 in which constituent components of a trading strategy are determined and displayed. The example constituent components constituent component interface 600 is provided to the constituent components handling module 500 to enable determining and displaying the inter-relatedness of the components of a trading strategy. In the illustrated example of FIG. 6, the constituent components constituent component interface 600 includes an example market grid 605 to provide market information (e.g., real-time market information) for selected objects (e.g., trading strategies, components, etc.) and an example order pane 610 to facilitate executing a trade. The example market grid 605 presents trading strategies available for selecting. For example, the market grid 605 includes an example trading strategy 615 and example components 620 (e.g., legs). The example trading strategy 615 is defined by an example implied leg A 625 and an example implied leg B 630.

Returning to the example constituent components handling module 500 of FIG. 5, the example price handling module 530 determines a value of each component of the trading strategy and calculates the price of the selected trading strategy according to the relationship defined by the trading strategy. For example, the price handling module 530 may query the example data structure 515 for the components of a “Spread AB” trading strategy (e.g., “Leg A” and “Leg B”) and determine the value of each of the respective components. In the illustrated example, the price handling module 530 causes the interface handling module 520 to display the price of the trading strategy after the price is calculated. For example, the price handling module 530 can send a message to the interface handling module 520 to display the calculated price of the “Spread AB” trading strategy.

In some examples, the constituent components handling module 500 updates the market grid to present information about the components of the trading strategies 517. For example, as the price handling module 530 calculates the value of each of the respective components of the “Spread AB” trading strategy, the price handling module 530 causes the interface handling module 520 to display the respective values of the components. For example, the price handling module 530 can calculate the value of the “Leg A” component and instruct the interface handling module 520 to display the value of the “Leg A” component.

In some examples, one or more of the components of the trading strategy 517 may include implied orders. Thus, it may be useful to present information on implied prices and/or quantities that characterize the market (e.g., direct orders and/or implied orders). In the illustrated example, when the price handling module 530 calculates the value of the respective trading strategy 517, the price handling module 530 instructs the interface handling module 520 to display the values of the respective components of the trading strategy 517. For example, an implied contract may not be included in the market grid when the trading strategy is selected, but the implied contract is added to the market grid when the market grid is updated.

In one example, the price handling module 530 may calculate implied quantities and implied prices based on information associated with direct orders in a combination of outright markets that imply orders into a spread market, also commonly referred to as “implied in” orders. For example, using three tradable objects A, B, and C, the tradable objects A, B, C can imply orders into three spread markets. Specifically, an example tradable object AB may be a first spread strategy having the tradable object A as a first leg and the tradable object B as a second leg. An example tradable object AC may be a second spread strategy having the tradable object A as a first leg and the tradable object C as a second leg. Finally, an example tradable object BC may be a third spread strategy having the tradable object B as a first leg and the tradable object C as a second leg.

When an exchange (e.g., the example exchange 130 of FIG. 1 and/or the example exchange 230 of FIG. 2) provides a spread, the exchange may provide a relationship between two or more tradable objects that form the spread. For example, the following relationships may be used for the spreads AB, AC and BC described above:

Spread AB=Leg A−Leg B EQN (1)

Spread AC=Leg A−Leg C EQN (2)

Spread BC=Leg B−Leg C EQN (3)

Further, each equation above may be used to generate two separate equations, one for buying and one for selling a spread. For example, using the first spread equation (EQN (1)), the following buy and sell definitions may be derived:

Buy AB=Buy A−Sell B EQN (4)

Sell AB=Sell A−Buy B EQN (5)

The relationships in EQNs. (4) and (5) may then be used to calculate bid (buy) and ask (sell) implied quantities and prices.

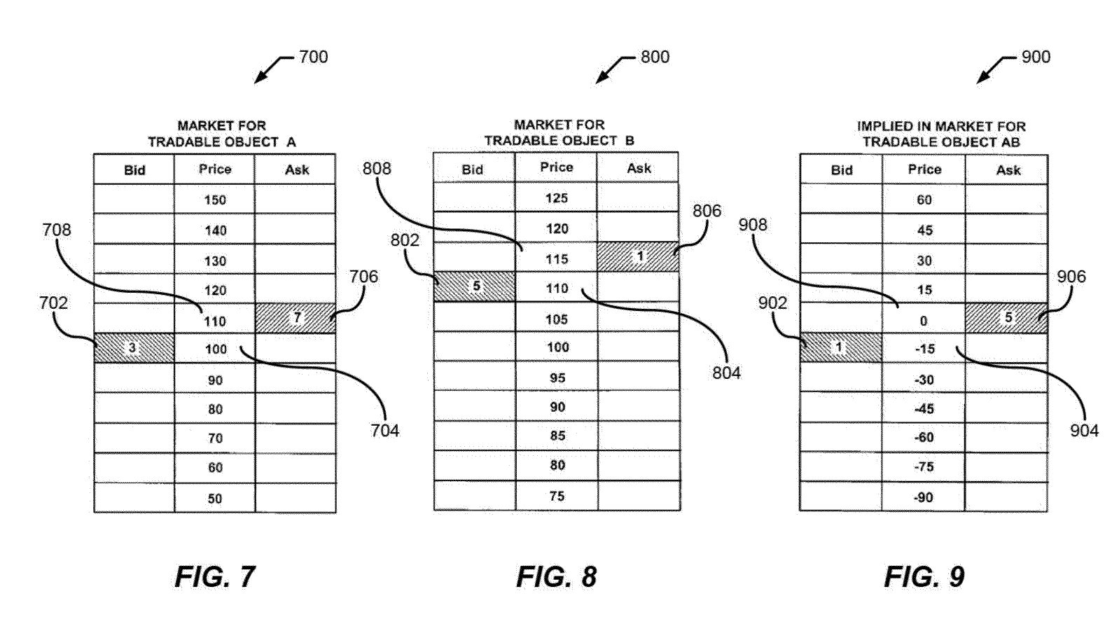

FIG. 7 illustrates an example graphical user interface 700 displaying inside market information associated with a first tradable object A being traded on a first exchange. As described above, the inside market represents the highest buy price and the lowest sell price. As illustrated in the graphical user interface 700, there is an example bid quantity 702 of three (3) at an example bid price 704 of 100 (e.g., 100 dollars), and there is an example ask quantity 706 of seven (7) at an example ask price 708 of 110 (e.g., 110 dollars). In the illustrated example of FIG. 7, bid orders and ask orders are as assumed to be direct, meaning that the orders were placed directly on the market associated with the first tradable object A.

FIG. 8 illustrates an example graphical user interface 800 displaying inside market information associated with a second tradable object B. As illustrated in the graphical user interface 800, there is an example bid quantity 802 of five (5) at an example bid price 804 of 110 (e.g., 110 dollars), and there is an example ask quantity 806 of one (1) at an example ask price 808 of 115 (e.g., 115 dollars). Also, similarly to FIG. 7, in the illustrated example of FIG. 8, orders associated with the tradable object B are assumed to be direct orders (e.g., placed directly into a market associated with the second tradeable object B).

The orders associated with the first tradable object A and the second tradable object B can imply orders into a spread tradable object AB. FIG. 9 illustrates an example graphical user interface 900 displaying implied prices and implied quantities for a spread AB having the tradable object A as a first leg and the tradable object B as a second leg. The implied prices for the spread AB can be calculated using EQNs. (4) and (5) above. As illustrated in the graphical user interface 900, there is an example implied bid quantity 902 of one (1) at an example implied bid price 904 of minus fifteen (−15), and there is an example implied ask quantity 906 of five (5) at an example implied ask price 908 of zero (0).

It should be understood that if quantities at price levels other than the inside market are available, implied prices and implied quantities for the spread AB may be calculated for quantities at those price levels as well. For example, using EQN. (4), the price to buy the spread AB may be found by subtracting the example ask price 808 (e.g., 115) from the example buy price 702 (e.g., 100) (e.g., 100−115), which is the example implied bid price 904 (e.g., −15). In this example, the quantity at the implied bid price 904 (e.g., −15) is the minimum of the bid quantity 702 (3) and the ask quantity 806 (1), which is the example implied bid quantity 902 (1). It should be understood that the minimum of the quantities is used because once a quantity associated with the second leg is used (e.g., used up), there is no quantity left to match the quantity remaining in the first leg (e.g., two (2)).

Similarly, using EQN (5), a price to sell the spread AB may be found by subtracting the example bid price 804 (e.g., 110) from the example ask price 708 (110) (e.g., 110−110), which is the example implied ask price 908 (e.g., zero (0)). In this example, the implied ask quantity 906 is five (5) based on the minimum of the ask quantity 706 (e.g., 7) and the bid quantity 802 (e.g., 5) associated with the two legs of the spread AB. Referring to FIG. 9, the computed implied quantities and prices are shown for the spread AB.

In certain embodiments, tradable objects are expressed in a vector notation. For example, it may be desirable to express a market associated with each tradable object as an identity vector, such that the tradable object A may be represented by the vector (1, 0, 0), the tradable object B may be represented by the vector (0, 1, 0), and the spread of tradable objects AB may be represented by the vector (0, 0, 1). In some such embodiments, each vector is of the same size, where the size of the vector corresponds to the number of tradable objects in the set. In this example, there are three tradable objects so that each vector has three dimensions. Also, strategy markets with two or more legs can be also expressed as a definition vector. For example, buying spread AB can be also defined using the vector (1, −1, 0), which means buying one quantity of the tradable object A and selling one quantity of the tradable object B. In such an embodiment, selling the spread AB can be defined using the vector (−1, 1, 0), which represents selling one quantify of the tradable object A and buying one quantity of the tradable object B.

The price handling module 530 may perform additional and/or different implied calculations such as those described in commonly-owned U.S. Pat. No. 7,765,134, filed on Mar. 31, 2003 and titled “System and Method for Determining Implied Market Information,” the content of which is incorporated herein by reference.

In the illustrated example of FIG. 5, the constituent components handling module 500 includes the example indicators handling module 540 to display indicators for selected trading strategies 517. For example, when the first trading strategy is selected in the market grid (e.g., via a market participant such as a trader and/or a trading application), the first trading strategy may be overlaid with a first indicator and/or symbol (e.g., a strategy indicator). For example, an indicator and/or symbol may be text (e.g., “SELECTED”), icons (e.g., an asterisks (*)), colors (e.g., a selected trading strategy is colored green, etc.), lines (e.g., thick border lines, etc.) and/or other graphical representations. In the illustrated example, when an indicator is applied to the market grid, the indicators handling module 540 displays a highlighting as an overlay to the row associated with the selected trading strategy. For example, when the first trading strategy is selected, the indicators handling module 540 overlays the first trading strategy (e.g., one or more rows with information associated with the first trading strategy) with a green highlighting having a transparency parameter of fifty percent (50%).

As described above, it is useful to display information that characterizes (e.g., completely characterizes) a market. To this end, the example indicators handling module 540 applies a second indicator (e.g., an implied contract indicator) to the respective components of the selected trading strategy 517. For example, the indicators handling module 540 can apply a green highlighting overlay having a transparency parameter of seventy percent (70%) to the constituent components of the trading strategy 517. In this manner, the inter-related nature of the components of the trading strategy 517 can be quickly discerned. For example, by observing that a green highlighting overlay is applied upon components and the first trading strategy, a market participant can quickly determine the constituent components that are related to the first trading strategy 517. Further, because a highlighting overlay having a different transparency parameter (e.g., seventy percent versus fifty percent) is applied to the components, it can be ascertained that the price of the first trading strategy 517 relies upon which constituent components. In the illustrated example, the price handling module 530 notifies the indicators handling module 540 of the constituent components. In some examples, the indicators handling module 540 may query the data structure 515 for the constituent components of the selected trading strategy 517.

Referring to the example constituent component interface 600 of FIG. 6, the example trading strategy 615 is selected and the example indicators handling module 540 applies a red highlighting overlay having a fifty percent (50%) transparency parameter to the trading strategy 615 (illustrated using a striped background). In the illustrated example, the indicators handling module 540 applies a red highlighting overlay having a seventy percent (70%) transparency parameter to the constituent components 625, 630 (illustrated using a crisscross background). In this manner, a selected trading strategy (e.g., the trading strategy 615) can be quickly identified, as well as those components that constitute the trading strategy (e.g., the constituent components 625, 630).

In the illustrated example, the indicators handling module 540 includes an example rules set 545 that defines the indicator preferences. For example, the rules set 545 can specify whether to apply indicators to selected trading strategies 517 and/or constituent components of the selected trading strategies 517, what type of indicator to apply to the selected trading strategies 517 and/or constituent components (e.g., highlighting, text, icons, lines, etc.), how to handle indicators when a different trading strategy 517 is selected (e.g., apply a different colored highlighting overlay, remove the indicators from the previously selected trading strategy 517 and its constituent components, etc.), etc. In some examples, the rules set 545 specifies how to handle changes in the relied upon components of a trading strategy 517. For example, calculating the value of a trading strategy 517 at a first time may rely upon three components and calculating the value of the same trading strategy 517 at a second may rely upon a different combination of components (e.g., two components, three components, four components, etc.). In some such examples, the example rules set 545 may specify whether defunct components that were previously relied upon should be removed from the market grid, should have a third indicator applied, etc. For example, the indicators handling module 540 may overlay a first highlighting having a transparency parameter of fifty percent on a selected trading strategy 517, may overlay a second highlighting having a transparency parameter of seventy percent on the currently relied upon components of the trading strategy 517, and may overlay a third highlighting having a transparency parameter of ninety percent (90%) on now defunct components.

In the illustrated example, the indicators handling module 540 maintains a record of the indicators applied on the components of the market grid. For example, the indicators handling module 540 may set the status of an indicator flag to ‘true’ when a displayed component is a constituent component. The example indicators handling module 540 may set the status of the indicator flag to ‘false’ when a constituent component is no longer a relied upon component (e.g., is a defunct component). Although the example indicators handling module 540 utilizes a true/false system to maintain a record of the indicators applied on the components, other systems of maintaining a record may additionally or alternatively be used. For example, the indicators handling module 540 may use a two-bit system to record when an indicator is applied to a selected trading strategy 517, when an indicator is applied to a constituent component, when an indicator is applied to a defunct component, and when no indicator is applied to a component.

Furthermore, although the example indicators handling module 540 applies highlighting that is overlaid on a row to indicate selected trading strategies and/or constituent components, other approaches may additionally or alternatively be used. For example, the indicators handling module 540 may launch a “hovering” or “floating” window from a row that has implied components. For example, when a user interface selection device (e.g., a mouse) is positioned on a trading strategy 517, a floating window may launch that identifies the constituent components and information about the components. In some examples, an indicator (e.g., a color or symbol) can be applied to a trading strategy 517 in the market grid that indicates components are implying (e.g., the trading strategy 517 includes constituent components).

In some examples, the indicators handling module 540 may launch a “fly-out” window and/or a “docked style” window from the example trading interface 600 of FIG. 6. For example, an automated trading tool may include MD Trader®, provided by Trading Technologies. In some such examples, each row in the trading interface 600 may include, for example, a contract name, a bid price/quantity, and a ask price/quantity. The example indicators handling module 540 can use different indicator schemes (e.g., coloration schemes) to show links between prices in the docked grid presented by the trading interface 600 and the corresponding value column or axis such as a price ladder. For example, prices arranged into value levels to form a value axis can have indicator(s) applied corresponding to indicators in the fly-out grid (e.g., a price that is thirty percent (30%) purple represents that thirty percent (30%) of its volume is implied by a corresponding purple row in the fly-out window). In some examples, the trading interface 600 may include separate columns next to the price columns to display the indicators.

In some examples, an automated trading tool may include synthetic order manager (SOM). In some such examples, SOM order functionality may be enhanced to enable triggering (e.g., slicing) orders (e.g., stop if touched, volume slicers, etc.) off of a contract that implies. For example, a SOM order can be configured to add slices to a spread (e.g., WTI Feb14/WTI Mar14 calendar spread) as orders are traded across contracts (e.g., all contracts) that imply (e.g., WTI Feb14, WTI Mar14, and/or WTI Mar14/WTI Apr14 calendar spread, etc.).

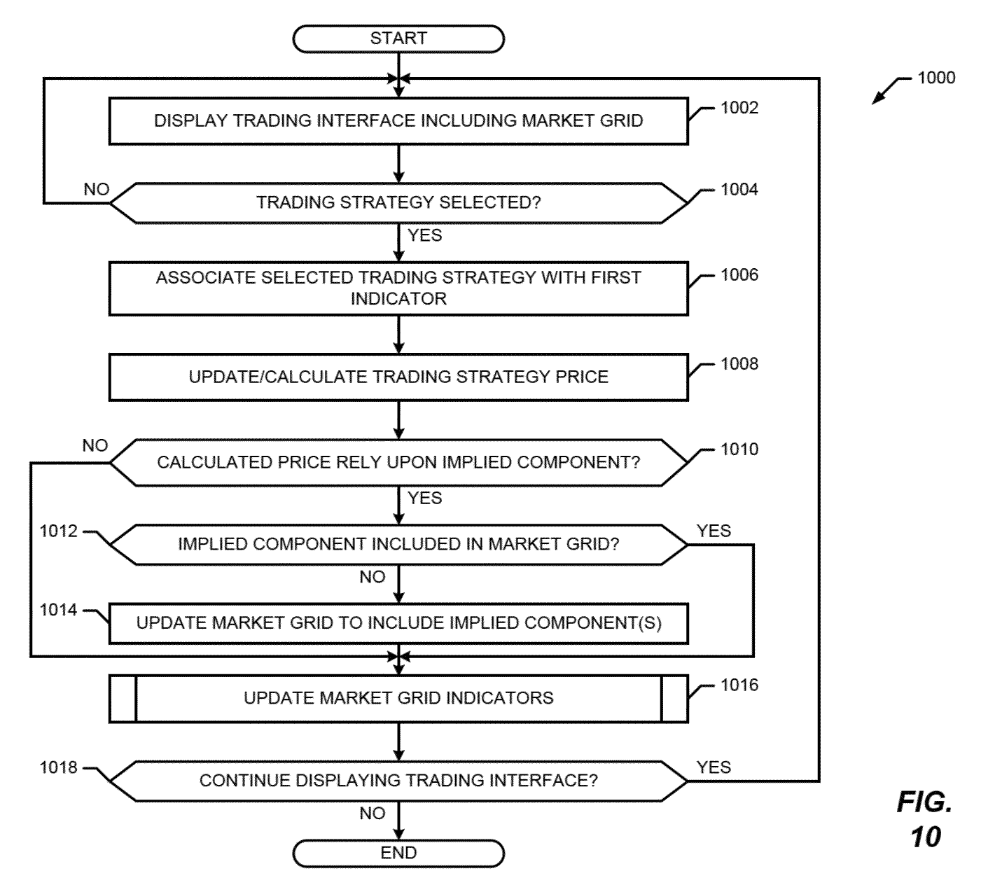

FIG. 10 is an example flow diagram of an example method 1000 including instructions to implement the constituent components handling module 500 of FIG. 5. Upon activation of the constituent components handling module 500, control begins at block 1002. At block 1002, the example constituent components handling module 500 displays a trading interface including a market grid. For example, the interface handling module 520 may display and/or generate a trading interface such as the example constituent component interface 600 of FIG. 6 including the example market grid 605. The example interface handling module 520 displays the one or more trading strategies that are available for selection. For example, the example trading application 330 of FIG. 3 may be used in conjunction with the example trading strategy module 510 to define trading strategies, which the trading strategy module 510 stores in the example data structure 515.

At block 1004, the constituent components handling module 500 determines whether a trading strategy 517 included in the market grid was selected. For example, the interface handling module 520 may communicate with the input device(s) 318 and/or the output device(s) 320 of FIG. 3 to determine when a trading strategy 517 is selected from the market grid. If, at block 1004, the constituent components handling module 500 determined no trading strategy 517 was selected, then control returns to block 1002 to display the trading interface including the market grid (e.g., the example constituent component interface 600). In some examples, the constituent components handling module 500 may update (e.g., refresh) the information displayed in the trading interface.

If, at block 1004, the constituent components handling module 500 determined a trading strategy 517 was selected, then, at block 1006, the constituent components handling module 500 associates the selected trading strategy 517 with a strategy indicator. For example, the indicators handling module 540 can apply a highlighting overlay having a transparency parameter of fifty percent on the selected trading strategy 517. At block 1008, the constituent components handling module 500 updates and/or calculates the price (e.g., value) of the selected trading strategy 517. For example, the price handling module 530 may retrieve information regarding constituent components (e.g., from the data structure 515) and determine the value of the respective components. The example price handling module 530 may then calculate the price of the selected trading strategy 517 and/or cause the interface handling module 530 to update the displayed price.

At block 1010, the constituent components handling module 500 determines whether the calculated price relies upon implied components. For example, the price handling module 530 may determine which, if any, of the components of the trading strategy is an implied order in a spread market rather than a direct order in an outright market. If, at block 1010, the constituent components handling module 500 determined that the calculated price relies upon implied components, then, at block 1012, the constituent components handling module 500 determines whether the implied component is included in the market grid. If, at block 1012, the constituent components handling module 500 determined that the market grid does not include the implied component, then, at block 1014, the constituent components handling module 500 updates the market grid to include the implied component. For example, the price handling module 530 may instruct the interface handling module 520 to add the implied component to the market grid.

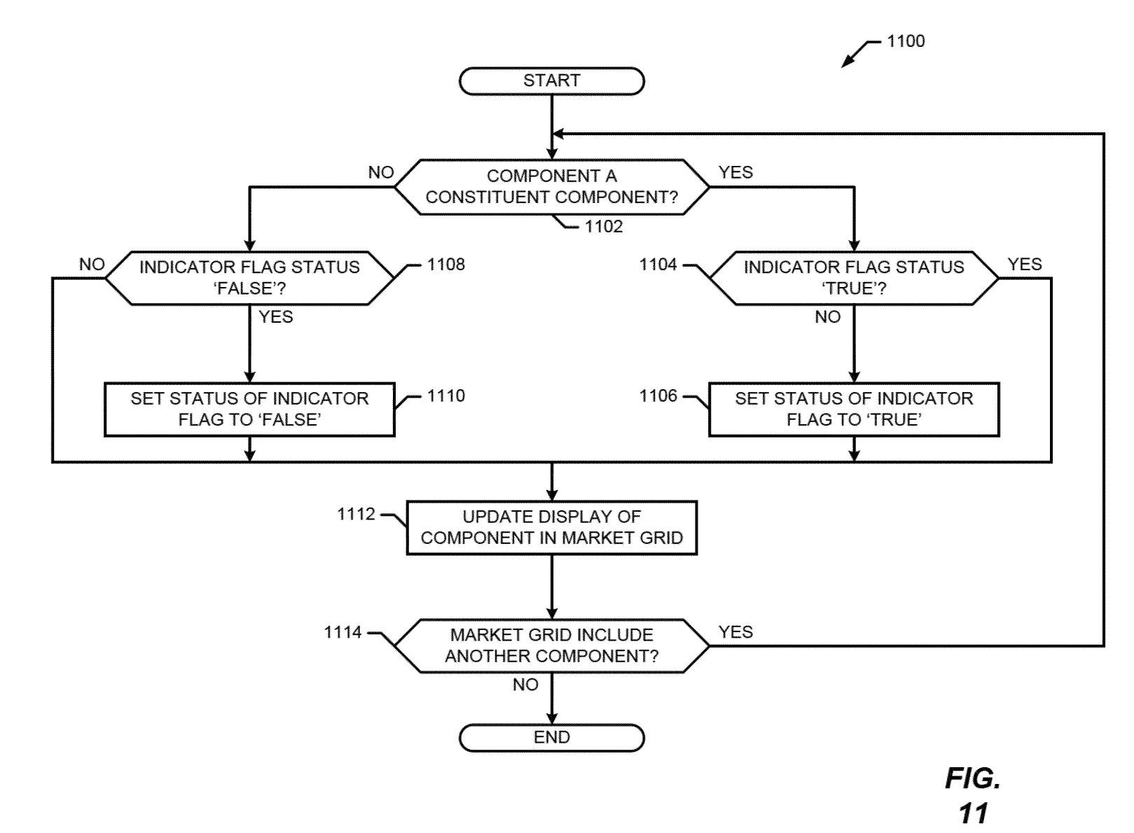

If, at block 1010, the constituent components handling module 500 determined that the calculated price of the trading strategy 517 did not rely upon an implied component, or, if, at block 1012, the constituent components handling module 500 determined that the implied component is included (e.g., displayed) in the market grid, or after the constituent components handling module 500 updates the market grid to include the implied component at block 1014, then, at block 1016, the constituent components handling module 500 updates the market grid indicators. For example, the indicators handling module 540 may apply a strategy indicator to the selected trading strategy 517, may apply an implied contract indicator to the constituent components of the trading strategy 517, may apply a third indicator to defunct components, etc. In the illustrated example, the operation of block 1016 may be implemented using the process of FIG. 11.

At block 1018, the constituent components handling module 500 determines whether to continue displaying the trading interface. For example, the trading application 330 may be exited. If, at block 1018, the constituent components handling module 500 determined to continue displaying the trading interface, then control returns to block 1002 to display the trading interface including the market grid (e.g., the example constituent component interface 600). If, at block 1018, the constituent components handling module 500 determined not to continue displaying the trading interface, then the example process of FIG. 10 ends.

FIG. 11 is an example flow diagram of an example method 1100 including instructions to implement the indicators handling module 540 of FIG. 5. The example program 1100 of FIG. 11 may be used to implement block 1016 of FIG. 10. At block 1102, the example indicators handling module 540 determines whether a component is a constituent component. For example, the indicators handling module 540 may traverse the components displayed in the market grid (e.g., the example market grid 605 of the example constituent component interface 600 of FIG. 6) and select a first component to process. If, at block 1102, the indicators handling module 540 determined that the component is a constituent component, then, at block 1104, the indicators handling module 540 determines the status of an indicator flag. If, at block 1104, the indicators handling module 540 determined that the status of the indicator flag is ‘true,’ then the component is a constituent component and an indicator was previously applied to the component. Control then proceeds to block 1112 to update the component indicator of the component based on the status of the indicator flag.

If, at block 1104, the indicators handling module 540 determined that the status of the indicator flag is not ‘true’ (e.g., the status of the indicator flag is ‘false’), then, at block 1106, the indicators handling module 540 sets the status of the indicator flag to ‘true.’ Control then proceeds to block 1112 to update the component indicator of the component based on the status of the indicator flag.

If, at block 1102, the example indicators handling module 540 determined that the component is not a constituent component, then, at block 1108, the indicators handling module 540 determines the status of the indicator flag for the component. If, at block 1108, the indicators handling module 540 determined that the status of the indicator flag is ‘false,’ then the component is not a constituent component and no indicator was previously applied to the component. Control then proceeds to block 1112 to update the component indicator of the component based on the status of the indicator flag.

If, at block 1108, the indicators handling module 540 determined that the status of the indicator flag is not ‘false’ (e.g., the status of the indicator flag is ‘true’), then, at block 1110, the indicators handling module 540 sets the status of the indicator flag to ‘false.’ Control then proceeds to block 1112 to update the component indicator of the component based on the status of the indicator flag.

At block 1112, the indicators handling module 540 updates the display of the component in the market grid (e.g., the example market grid 605 of the example constituent component interface 600). For example, the indicators handling module 540 can remove the highlighting overlay on the component, add highlighting overlay on the component, modify the highlighting overlay on the component, etc. At block 1114, the indicators handling module 540 determines whether the market grid includes another component to process. If, at block 1114, the indicators handling module 540 determined the market grid includes another component to process, then control returns to block 1102 to determine whether the component is a constituent component. Otherwise, if, at block 1114, the indicators handling module 540 determined the market grid does not include another component to process, the example program 1100 of FIG. 11 ends.

In operation, a market grid can include a portion of the components of a trading strategy. For example, a first trading strategy may define a relationship between two tradeable objects in a same first market (e.g., “Leg A” and “Leg C” of the first market), and a second trading strategy may define a relationship between two tradeable objects in a same, second market (e.g., “Leg B” and “Leg D” of the second market). In some such examples, the market grid may include (e.g., display) the first trading strategy, the second trading strategy and the “Spread AB” trading strategy. In the illustrated example, when the first trading strategy is selected (e.g., by a market participant), the price handling module 530 may calculate the value of the “Leg A” component, the value of the “Leg C” component, and the value (e.g., price) of the first trading strategy. The price handling module 530 can also instruct the interface handling module 520 to display the “Leg A” component and the “Leg C” component in the market grid. If the “Spread AB” trading strategy is selected next, the market grid includes the “Leg A” component, but not the “Leg B” component. In some such examples, when the example price handling module 530 calculates the price of the “Spread AB” trading strategy, the price handling module 530 causes the interface handling module 520 to add the “Leg B” component to the market grid. In this manner, the market grid includes direct orders (e.g., the “Leg A” component and the “Leg C” component) and/or indirect orders (e.g., the “Leg B” component) that are useful in characterizing the “Spread AB” market (e.g., the “Leg A” component and the “Leg B” component are constituent components (e.g., relied upon) by the price handling module 530 when calculating the value of the “Spread AB” trading strategy). For example, both the “Leg A” component and the “Leg B” component impact the price of the “Spread AB” trading strategy, and, thus, it is useful to display information (e.g., values, prices, etc.) of the “Leg A” component and the “Leg B” component.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
defining, via a trading interface implemented by a trading device, a trading strategy including a first contract associated with a first tradeable object and a second contract associated with a second tradeable object;
receiving, by the trading device, market data provided by the electronic exchange, the market update includes price and quantity information related to the first and second tradeable objects;
determining, by the trading device, that at least one of a first price and a first quantity associated with the first contract is implied based on at least one of a second price and a second quantity associated with the second contract;
receiving, via the trading interface implemented by the trading device, a selection input corresponding to the trading strategy listed in the trading interface;
displaying, via the trading interface implemented by the trading device, a strategy indicator arranged to identify the trading strategy in the trading interface, wherein the strategy indicator is generated in response to the received selection input; and
displaying, via the trading interface implemented by the trading device, an implied indicator arranged to identify the first contract and configured to reflect a link between at least the first contract and the selected trading strategy.

2. The method of claim 1, wherein the strategy indicator includes a first highlight associated with the defined trading strategy and the implied indicator includes a second highlight associated with at least the first tradeable object.

3. The method of claim 2, wherein the second highlight is nested with respect to the first highlight.

4. The method of claim 2, wherein the first highlight reflects a first transparency parameter and the second highlight reflects a second transparency parameter, and wherein the first transparency is less than the second transparency.

5. The method of claim 1 further comprising:
updating the implied indicator displayed in the trading interface to reflect removal of the implied price from the calculated price.

6. The method of claim 5, wherein updating the implied indicator generated in the trading interface includes a third highlight associated with the first contract.

7. The method of claim 5 further comprising removal of the first contract from the trading interface.

8. The method of claim 1, wherein the trading strategy includes a third contract associated with a third tradeable object.

9. The method of claim 8 further comprising:
displaying, via the trading interface implemented by the trading device, a second implied indicator arranged to identify the third contract and configured to reflect a link between at least the third contract and the selected trading strategy.

10. A tangible computer readable storage medium comprising instructions that, when executed, cause a trading interface implemented by a trading device to at least:
receive a definition of a trading strategy including a first contract associated with a first tradeable object and a second contract associated with a second tradeable object;
receive market data provided by the electronic exchange, the market update includes price and quantity information related to the first and second tradeable objects;
determine that at least one of a first price and a first quantity associated with the first contract is implied based on at least one of a second price and a second quantity associated with the second contract;
receive a selection input corresponding to the trading strategy listed in the trading interface;
display a strategy indicator arranged to identify the trading strategy in the trading interface, wherein the strategy indicator is generated in response to the received selection input; and
display an implied indicator arranged to identify the first contract and configured to reflect a link between at least the first contract and the selected trading strategy.

11. The tangible computer readable storage medium of claim 10, wherein the strategy indicator includes a first highlight associated with the defined trading strategy and the implied indicator includes a second highlight associated with at least the first tradeable object.

12. The tangible computer readable storage medium of claim 11, wherein the second highlight is nested with respect to the first highlight.

13. The tangible computer readable storage medium of claim 11, wherein the first highlight reflects a first transparency parameter and the second highlight reflects a second transparency parameter, and wherein the first transparency is less than the second transparency.

14. The tangible computer readable storage medium of claim 10 wherein the instructions further cause the trading interface to update the implied indicator displayed in the trading interface to reflect removal of the implied price from the calculated price.

15. The tangible computer readable storage medium of claim 14, wherein the update to the implied indicator generated in the trading interface includes a third highlight associated with the first contract.

16. The tangible computer readable storage medium of claim 14 wherein the instructions further cause the trading interface to remove the first contract from the trading interface.

17. The tangible computer readable storage medium of claim 10, wherein the trading strategy includes a third contract associated with a third tradeable object.

18. The tangible computer readable storage medium of claim 17 wherein the instructions further cause the trading interface to display a second implied indicator arranged to identify the third contract and configured to reflect a link between at least the third contract and the selected trading strategy.
